(19) United States
(12) Patent Application Publication
(10) Pub. No.: US 2022/0091429 A1
(43) Pub. Date: Mar. 24, 2022

(54) Optical Elements with Gradient Refractive Index and Optical Systems Including Such Optical Elements

(71) Applicant: EDMUND OPTICS, INC., Barrington, NJ (US)

(72) Inventors: Greg HOLLOWS, Cherry Hill, NJ (US); Shelby AMENT, Voorhees, NJ (US); Nathan CARLIE, Cherry Hill, NJ (US)

(73) Assignee: EDMUND OPTICS, INC., Barrington, NJ (US)

(21) Appl. No.: 17/424,628

(22) PCT Filed: Jan. 28, 2020
(86) PCT No.: PCT/US2020/015298

§ 371 Date: Jul. 21, 2021

Related U.S. Application Data
(60) Provisional application No. 62/797,708, filed on Jan. 28, 2019.

(51) Int. Cl. G02B 27/09; G02B 3/00

(52) U.S. Cl. CPC G02B 27/0927; H01S 3/0071; G02B 27/0955; G02B 3/0087

(57) ABSTRACT

An optical element includes a first surface and an opposed second surface. A refractive index of the optical element varies from a center of the optical element to a perimeter of the optical element such that the optical element is configured to convert a Gaussian input beam introduced to the first surface into an output beam from the second surface with a substantially flat irradiance profile along at least one axis. The optical element can have a refractive index that varies along an axis perpendicular to the optical axis of the optical element and has a profile that is concave up at a center of the optical element.

### CROSS-REFERENCE TO RELATED APPLICATIONS

This application claims priority to U.S. Provisional Patent Application No. 62/797,708, filed Jan. 28, 2019, the entirety of which is hereby incorporated herein by reference.

### BACKGROUND

Lasers typically produce a beam having a Gaussian irradiance profile wherein the irradiance is highest at the center of the beam and falls off rapidly at radial distances away from the center. Refractive Powell lenses, or laser line generator lenses, are used to convert Gaussian laser beams into lines having uniform irradiance along the length of the line. This can be useful in a variety of applications, including machine vision applications. Refractive Powell lenses are typically formed by polishing, or rounding off, a portion of the lens such that the distance that a beam must travel through the lens varies from the center of the lens to the perimeter of the lens. For example, one surface of such lenses can take on the shape of a curved roof line. The process of mechanically forming such profiles is imprecise and iterative. Hence, these lenses are expensive to produce.

Gradient-index (GRIN) optics refers to optical effects resulting from a gradient of the refractive index of a material, such as a lens. GRIN lenses are typically used to reduce aberrations. The gradient of the refractive index can be created either by applying coatings to a component or by controlling the refractive index of the material itself such that the refractive index of the component varies from one position on the lens to another.

### SUMMARY

In one aspect, an optical element includes a first surface and an opposed second surface. A refractive index of the optical element varies from a center of the optical element to a perimeter of the optical element such that the optical element is configured to convert a Gaussian input beam introduced to the first surface into an output beam from the second surface with a substantially flat irradiance profile along at least one axis.

In another aspect, an optical system includes an optical element. The optical element includes a first surface and an opposed second surface. A refractive index of the optical element varies from a center of the optical element to a perimeter of the optical element such that the optical element is configured to convert a Gaussian input beam introduced to the first surface into an output beam from the second surface with a substantially flat irradiance profile along at least one axis.

In another aspect, an optical element includes a first surface and an opposed second surface. An optical axis of the optical element is orthogonal to the first surface. The optical element has a refractive index that varies along an axis perpendicular to the optical axis. A profile of the refractive index is concave up at a center of the optical element.

In another aspect, an optical system includes an optical element. The optical element includes a first surface and an opposed second surface. An optical axis of the optical element is orthogonal to the first surface. The optical element has a refractive index that varies along an axis perpendicular to the optical axis. A profile of the refractive index of the optical element is concave up at a center of the optical element.

### BRIEF DESCRIPTION OF THE DRAWINGS

The features of the embodiments described herein will be more fully disclosed in the following detailed description, which is to be considered together with the accompanying drawings wherein like numbers refer to like parts.

FIG. 1 is a schematic illustration of a lens, according to one embodiment described herein.

FIG. 2A shows a refractive index profile of the lens of FIG. 1 as it varies along the y-axis.

FIG. 2B shows a y-z cross-section of the lens of FIG. 1 illustrating a refractive index profile of the lens.

FIG. 3A shows a light-ray diagram of a beam passing through the lens of FIG. 1, wherein the density of light-rays corresponds to the irradiance distribution of the beam.

FIG. 3B shows a detail view of the light-ray diagram of FIG. 3A.

FIGS. 4A and 4B show an exemplary irradiance profile for a Gaussian input beam.

FIGS. 5A and 5B show an exemplary output irradiance profile formed by passing a Gaussian input beam such as that illustrated in of FIGS. 4A and 4B through the lens of FIG. 1.

FIG. 6 is a schematic illustration of a lens having a concave output surface, according to one embodiment.

FIG. 7 shows a refractive index profile of the lens of FIG. 6 as it varies along the y-axis.

FIG. 8 is a plot showing the relative illumination of an imaging lens and an irradiance profile required to compensate for the illumination fall-off of the lens.

FIG. 9 shows a refractive index profile of a lens as it varies along the y-axis configured for compensating for the illumination fall-off of an imaging lens.

FIG. 10 shows a light-ray diagram of a beam passing through a lens with a refractive index profile configured for compensating for the illumination fall-off of an imaging lens such as that illustrated in FIG. 9.

FIG. 11 shows the irradiance profile of an output beam formed by a lens with a refractive index profile configured for compensating for the illumination fall-off of an imaging lens such as that illustrated in FIG. 9.

### DETAILED DESCRIPTION

This description of preferred embodiments is intended to be read in connection with the accompanying drawings, which are to be considered part of the entire written description of this invention. The drawing figures are not necessarily to scale and certain features of the invention may be shown exaggerated in scale or in somewhat schematic form in the interest of clarity and conciseness. In the description, relative terms such as “horizontal,” “vertical,” “up,” “down,” “top,” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively or operably connected” is such an attachment, coupling or connection that allows the pertinent structures to operate as intended by virtue of that relationship.

In some cases, the drawings and the description herein are characterized by Cartesian (i.e., mutually perpendicular) axes x, y, and z. It should be understood that the axes and coordinate system can be transformed into other coordinates or topologies. As used herein, the z-axis is used to refer to the direction of light propagation, with the x and y axes being perpendicular thereto.

In the drawings and description that follows, certain values are provided—for example, for the refractive index of various lenses. It should be understood that these values are exemplary and optical elements and systems using other values still fall within the scope of this disclosure.

Described herein are optical elements—such as lenses—having a gradient refractive index (“GRIN lenses”) and optical systems including such lenses. The optical lenses described herein are configured to control the irradiance distribution of an output beam. For example, the lens may be configured to convert an input beam having a non-constant irradiance, such as a Gaussian beam, to an output beam that has a constant irradiance. The optical systems may have a target surface at a predetermined distance from the lens such that an output beam from the lens of known dimensions and constant irradiance contacts the target surface.

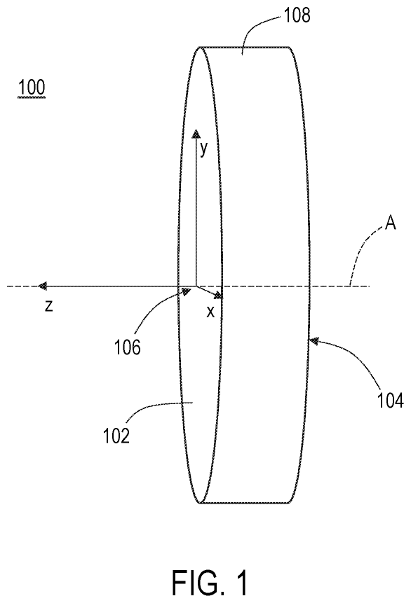

As shown in FIG. 1, a lens 100 includes an input surface 102 and an output surface 104. In various embodiments, as shown in FIG. 1, the input 102 and output 104 surfaces are substantially planar surfaces and an optical axis A is substantially orthogonal to the input 102 and output 104 surfaces. This optical axis A is configured to be positioned parallel to an input beam of an optical system, as will be described in more detail herein. The lens 100 can be any shape and size. For example, the lens 100 can have a circular cross-section. In one embodiment, the lens 100 has an outer diameter of 8.9 mm and a thickness of 5 mm. In other embodiments, the lens 100 may be rectangular or any other appropriate shape. The lens 100 can be constructed of any appropriate material, such as glass, and can include additives to control the refractive index of the lens 100 at various positions within the lens 100, as described further herein.

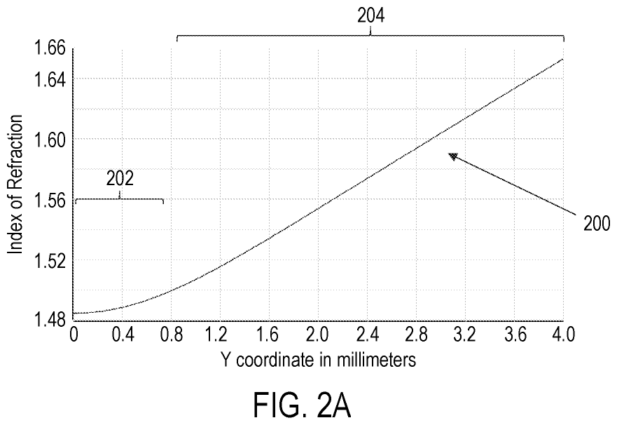

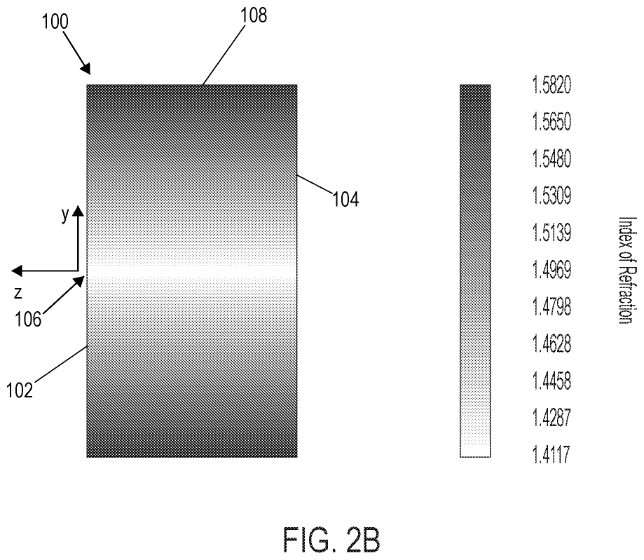

In various embodiments, the lens 100 has a refractive index that varies in a direction orthogonal to the optical axis A of the lens 100. In one embodiment, as shown in FIGS. 2A and 2B, the lens 100 has a gradient refractive index profile 200 that varies along the y-axis (shown in FIG. 1) from a center 106 (shown in FIG. 1) of the lens 100 to a perimeter 108 (shown in FIG. 1) of the lens 100. In other words, as shown in FIG. 2B, the lens 100 has a refractive index profile 200 that varies along an axis that is perpendicular to the optical axis A, which is aligned with the z-axis (shown in FIG. 1). For example, the lens 100 can have a refractive index gradient along the y-axis (shown in FIG. 1). The refractive index can be configured to have various desired profiles. In various embodiments, the refractive index is higher nearer the perimeter 108 of the lens 100 than nearer the center 106 of the lens 100. In one embodiment, as shown in FIGS. 2A and 2B, the refractive index may vary along the y-axis by about 0.17 from the center 106 of the lens 100 to the perimeter 108 of the lens 100. For example, the refractive index near the center 106 of the lens 100 may be about 1.41 and the refractive index near the perimeter 108 of the lens 100 may be about 1.58 (as illustrated in FIG. 2B). In other embodiments, the refractive index near the center 106 of the lens 100 may be about 1.48 and the refractive index near the perimeter 108 of the lens 100 may be about 1.65 (as illustrated in FIG. 2A).

Referring to FIG. 2A, the refractive index profile 200 of the lens 100 can include a concave up portion 202 and a linear portion 204. The concave up portion 202 is nearer to the center of the lens 100. The graph of FIG. 2A is oriented such that the center 106 of the lens 100 is at the position identified with a Y coordinate of 0. The linear portion 204 extends a substantial portion of the radius of the lens. The linear portion 204 may have any appropriate slope. For example, as shown in FIG. 2A, in one embodiment, the slope of linear portion 204 is about 0.05 mm⁻¹. In other embodiments, the slope of linear portion 204 is between about 0.025 mm⁻¹ to about 0.075 mm⁻¹.

FIG. 2B is a y-z cross-section of the lens 100 with an exemplary refractive index of the lens 100 illustrated by shading. FIG. 2B illustrates that the refractive index gradient of the lens 100 varies along the y-axis, with the refractive index being lower near the center 106 of the lens 100 (indicated by the lighter color) than near the perimeter 108 of the lens 100 (indicated by the darker coloring). As shown in FIG. 2B, the refractive index profile of the lens 100 is symmetric about the x-z plane. In other words, the refractive index increases from the relatively lower refractive index in the center 106 of the lens 100 in a symmetric fashion in both directions along the y-axis.

The delta between the maximum refractive index (at the perimeter 108) and minimum refractive index (at the center 106) of the lens 100 may be chosen to achieve a desired fan angle of the irradiance of the beam for a given lens thickness. For example, Table 1 provides exemplary refractive index deltas or gradients (Δn) for a lens thickness of 5 mm and a variety of fan angles.

TABLE 1
GRIN Powell Thickness = 5 mm

| fan angle (deg) | Δn |
|---|---|
| 5 | 0.026 |
| 15 | 0.092 |
| 30 | 0.191 |
| 45 | 0.285 |
| 60 | 0.372 |

Table 2 provides exemplary refractive index deltas or gradients (Δn) for a lens thickness of 10 mm and a variety of fan angles.

TABLE 2
GRIN Powell Thickness = 10 mm

| fan angle (deg) | Δn |
|---|---|
| 5 | 0.012 |
| 15 | 0.046 |
| 30 | 0.095 |
| 45 | 0.141 |
| 60 | 0.185 |

Table 3 provides exemplary refractive index deltas or gradients (Δn) for a fan angle of 30 degrees and a variety of lens thicknesses.

TABLE 3
Fan Angle = 30 degrees

| Thickness (mm) | Δn |
|---|---|
| 1 | 0.96 |
| 2.5 | 0.38 |
| 5 | 0.19 |
| 7.5 | 0.13 |
| 10 | 0.095 |

In various embodiments, the lens 100 has a refractive index profile 200 that is based on the following equation:

Δn≈(A·0.0312)/t

where Δn is the difference between the maximum refractive index and the minimum refractive index, t is the lens thickness in mm, and A is the fan angle in degrees.

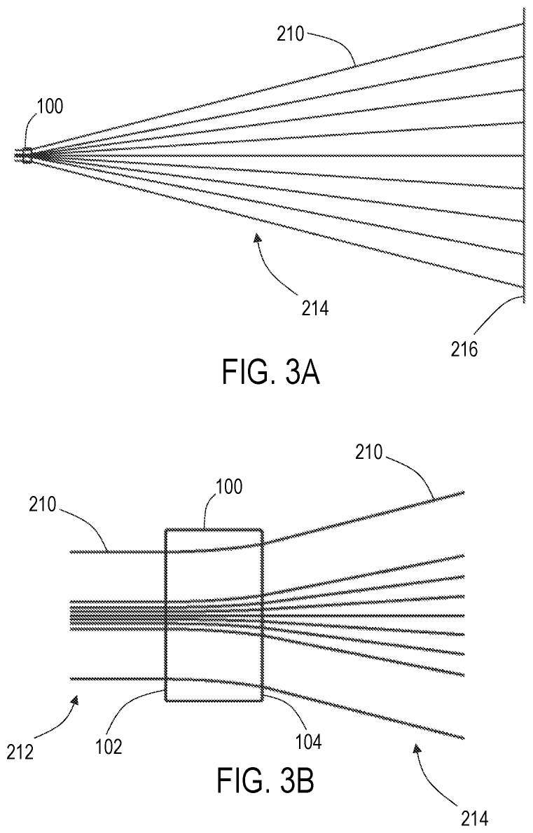

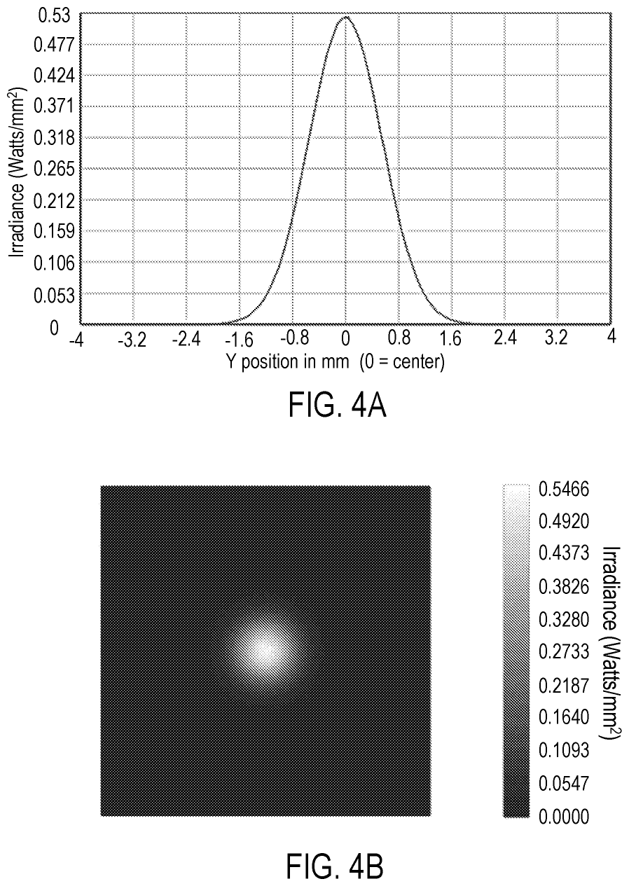

As a result of having a varying refractive index as described above, the lens 100 takes a Gaussian input beam and diverges it in the y direction at a desired fan angle (e.g., approximately 30 degrees) while also making the irradiance profile uniform in the y direction, as shown in FIGS. 3A and 3B. In FIGS. 3A and 3B, the density of the light-rays 210 corresponds to the irradiance distribution of the beam. An input beam 212 enters the lens 100 at input surface 102 and an output beam 214 exit the lens 100 at output surface 104. In the embodiment shown in FIGS. 3A and 3B, the light-rays 210 of the input beam 212 enter the input surface 102 parallel to the optical axis A (i.e., having a zero degree angle of incidence). The input beam 212 is a Gaussian beam with an irradiance that is higher at the center of the input beam 212 than at the outer portions of the input beam 212, as described in more detail below with reference to FIGS. 4A and 4B. As can be seen in FIG. 3A, the light-rays 210 of the output beam 214 are evenly spaced at the point at which they contact a target surface 216 indicating that the irradiance distribution is uniform at the point of contacting the target surface 216. The target surface 216 can be positioned at a desired distance from the lens 100 and the refractive index profile 200 can be configured such that the irradiance distribution is uniform at the position of the target surface 216, as described above.

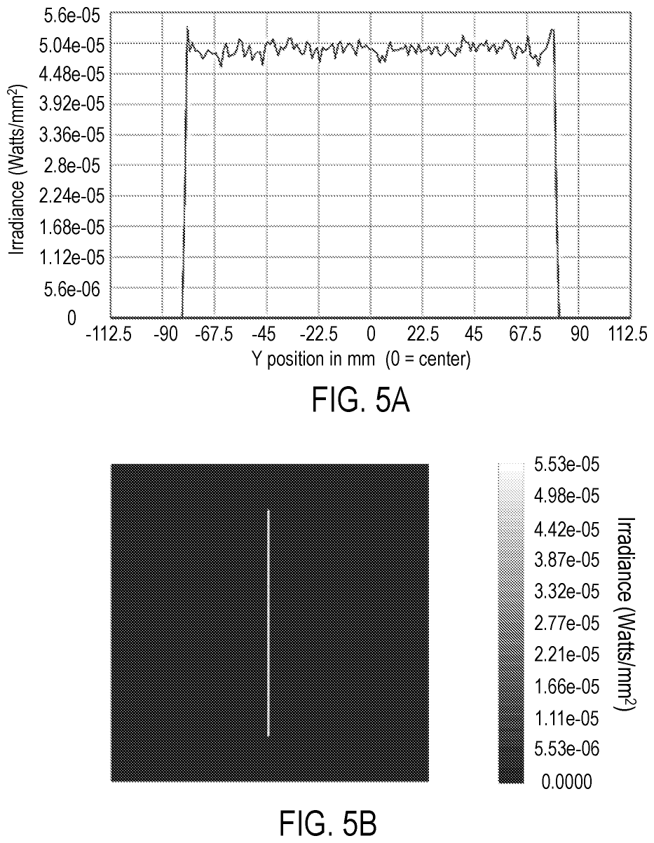

FIGS. 4A and 4B show an irradiance profile of an exemplary Gaussian input beam (e.g., input beam 212). As can be seen in these figures, the irradiance of the input beam is highest at the center of the beam and rapidly decreases at distances spaced apart from the center of the beam. FIGS. 5A and 5B show an irradiance profile of an output beam (e.g., output beam 214) formed by passing a Gaussian input beam through a lens 100 having a refractive index that varies in the y-direction as shown in FIGS. 2A and 2B and as described above. In the embodiment illustrated in FIGS. 5A and 5B, at a working distance of 300 mm, the line length of the output beam is approximately 160 mm. In other words, a target surface (e.g., target surface 216) located a distance of 300 mm from the lens will be exposed to a line of approximately constant irradiance with a length of approximately 160 mm. The refractive index profile 200 of the lens 100 can be tailored to provide a beam of a desired length at a desired distance from the lens 100. Hence, the lens 100 can be incorporated into various optical systems and provide a beam of constant irradiance. It should be understood that the values provided in FIGS. 4 and 5 are for illustration purposes only and the irradiance of the input and output beams can be selected as desired.

As can be seen in FIG. 5A, the irradiance of the output beam is approximately uniform along the length of the beam. As used herein, “approximately uniform” means that the value of the irradiance is within acceptable manufacturing variability (e.g., the irradiance varies by less than about 5% from the average irradiance over the length of the flat top, where the length is defined as the range over which the irradiance is >80% of its peak value).

In various embodiments, the refractive index of the lens 100 may vary in both the x and y directions. In such embodiments, the lens 100 may be configured such that the output beam is rectangular with an approximately uniform irradiance in both the x and y directions. The refractive index of the lens 100 may be configured to achieve a desired length and width of output beam on a target surface located a predetermined distance from the lens 100.

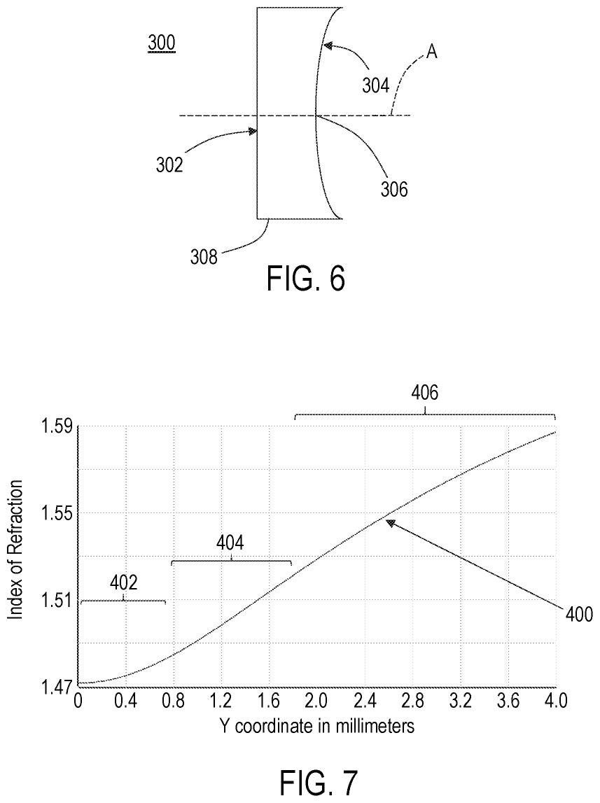

In another embodiment, as shown in FIG. 6, a lens 300 has an input surface 302 and an output surface 304. In this embodiment, the output surface 304 is concave (i.e., the lens 300 is a plano-concave lens). In other embodiments (not shown), the input surface 302 may also, or alternatively, be concave. With one or both of the input 302 and output 304 surfaces being concave, the refractive index range, or delta, required to achieve a uniform irradiance profile of the output beam for a particular lens thickness is reduced. Alternatively, a thinner lens may be used for a given refractive index range or delta.

An exemplary refractive index profile 400 of the lens 300 is shown in FIG. 7. The refractive index profile 400 includes a concave up portion 402 near the center 306 of the lens 300, a linear portion 404, and a concave down portion 406 near the perimeter 308 of the lens 300. Because the thickness of the lens 300 is greater nearer the perimeter 308 of the lens 300 than nearer the center 306, the refractive index need not increase as much as in an equivalent lens of constant thickness, such as that illustrated in FIGS. 1-2B.

In various embodiments, the lenses described herein (e.g., lens 100, 300) may be in the form of a “positive” lens that causes the output beam to come to an intermediate focus or, alternatively, a “negative” lens that does not.

In various other embodiments, the refractive index of the lens 100, 300 may be configured such that the irradiance of the output beam has a controlled non-constant profile. For example, in various embodiments, the refractive index of the lens 100, 300 is configured such that the irradiance of the output beam is higher near the edges of the output beam than the center of the output beam. Such a lens 100, 300 may be used, for example, in imaging systems in which there is a fall-off of relative illumination in the outer perimeter of the image, which may be an inherent property of the imaging system. By configuring the lens 100, 300 such that the irradiance of the output beam is higher near the outer portions of the output beam, the natural system fall-off may be compensated for to create an approximately uniform illumination—for example, on a camera sensor of the imaging system.

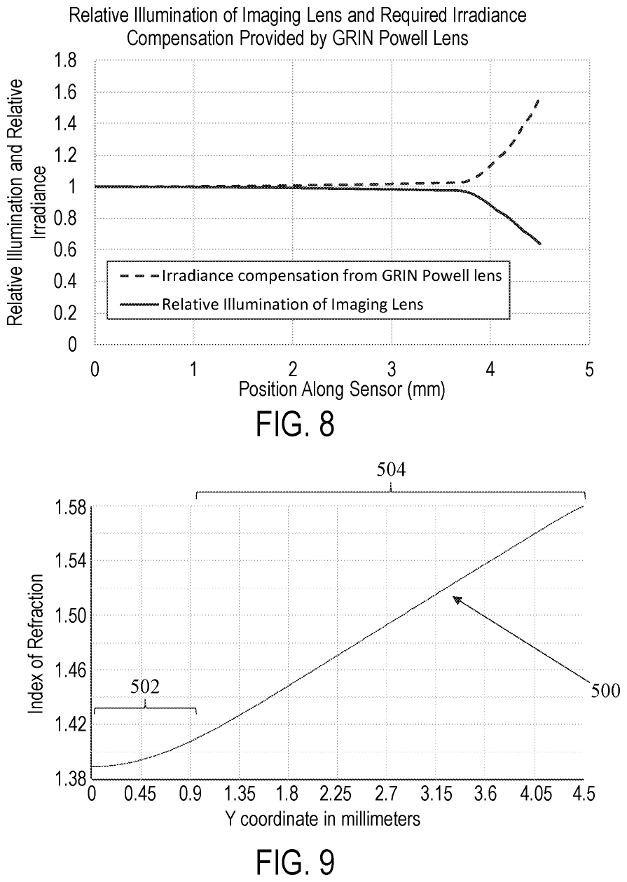

FIG. 8 shows a plot showing the relative illumination from the center to the edge of the image plane of a sensor from an exemplary prior art imaging lens (solid line). As can be seen in FIG. 8, the illumination drops off near the edge of the sensor. Also shown is the irradiance compensation required from a GRIN Powell lens (dashed line) to compensate for the illumination fall-off of the imaging system. Use of a lens with such an irradiance compensation allows the GRIN lens to compensate for the fall-off in illumination present in the imaging system to produce a more uniform illumination.

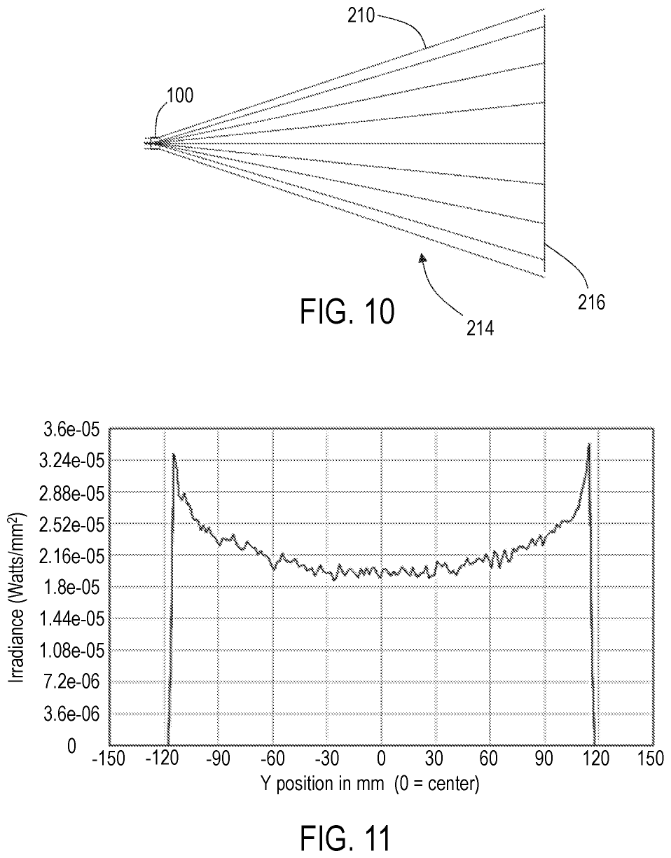

FIG. 9 shows an exemplary refractive index profile 500 of a lens 100, 300 having irradiance compensation (i.e., to compensate for the natural fall off of the illumination toward the edge of the output beam). The refractive index profile 500 includes a concave up portion 502 and a linear portion 504. In this embodiment, the lens 100, 300 has a similar refractive index profile to that shown above in FIG. 2A. However, the thickness of the lens is greater than the lens 100, 300 corresponding to the refractive index profile 200. This increased thickness leads the light-rays 210 to be refracted as shown in FIG. 10, with increased irradiance being directed toward the edge of the target surface 216. This is illustrated in FIG. 10 by the light-rays 210 at the edge of the output beam 214 being nearer together than those at the center of the output beam.

FIG. 11 shows an irradiance profile of an output beam (e.g., output beam 214) formed by a lens 100, 300 having the refractive index profile 500 shown in FIG. 9. As can be seen in FIG. 11, the irradiance is lower in the center of the output beam than near the edges, with the irradiance profile taking on a concave shape. The higher irradiance nearer the edges of the output beam is configured to compensate for the fall-off of an imaging system, as described above.

In various embodiments, the lenses described herein may be used in conjunction with one or more laser sources in a variety of optical systems. For example, in one embodiment, a machine-vision system includes a lens 100, 300 as described herein. The machine-vision system can be, for example, an optical code reader (e.g., a barcode scanner), line scan imagers, or optical sorting and quality check systems. The lenses described herein can also be used in light detection and ranging (LIDAR), range finding, and 3D mapping or scanning applications. The lenses described herein can also be used in general illumination applications, particularly the embodiments of the lenses described above in which the refractive index is rotationally symmetric.

A lens 100, 300 with refractive index that varies along one orthogonal direction to the beam may be equivalent in performance to a refractive Powell lens made by polishing the corner of a prism. One advantage of lenses described herein compared to an equivalent, traditional refractive Powell lens is that the lenses described herein can achieve greater control of the uniformity of the output beam during manufacturing as compared to the imprecise and iterative polishing process used in traditional Powell lenses.

Further, a GRIN Powell lens, as described herein, can be configured with a refractive index that varies along both orthogonal directions of the beam (i.e., in both the x and y directions shown in FIG. 1), resulting in a GRIN profile with x-y symmetry or rotational symmetry. It would be difficult to fabricate a refractive optical element to achieve the same result. This provides for the ability to create a uniform rectangle or ellipse of light, which is a distinct advantage of lenses described herein.

In addition, the plano-plano surfaces of some embodiments of the GRIN Powell lens described herein (e.g., lens 100) are simpler to integrate into an illumination assembly, easier to mount and align, and are more lightweight compared to the refractive Powell lens counterpart.

In various embodiments, an optical system includes a lens having a gradient refractive index and a target surface that is off-axis with respect to the input beam. The refractive index of the lens can be configured to, when exposed to the input beam, control the output beam such that the output beam has a constant irradiance on the target surface. In such embodiments, the refractive index profile of the lens may not be symmetric (e.g., with respect to the x-z plane).

The lenses described herein can be manufactured in any appropriate manner. For example, in one embodiment a lens is produced using an additive manufacturing process such as that described in U.S. Pat. No. 9,644,107 or a layered manufacturing process as described in U.S. Patent Application No. US20180133988A1, both of which are incorporated herein by reference in their entireties. For example, the lenses can include first and second nanocomposite-inks, each including nanofillers dispersed in a cured organic-matrix. The relative spatial distribution of the first and second nanocomposite-inks in the lens can be controlled to provide the desired refractive index profile. This can be done, for example, using an ink jet printing apparatus. Alternatively, the lenses described herein can be manufactured using a layered, laminated polymer material to produce the desired refractive index profile.

While the foregoing description and drawings represent preferred or exemplary embodiments of the present invention, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may be made without departing from the spirit of the invention. One skilled in the art will further appreciate that the invention may be used with many modifications of structure, arrangement, proportions, sizes, materials, and components and otherwise, used in the practice of the invention, which are particularly adapted to specific environments and operative requirements without departing from the principles of the present invention.

What is claimed is:

1. An optical element, comprising:
a first surface; and
an opposed second surface;
wherein a refractive index of the optical element varies from a center of the optical element to a perimeter of the optical element such that the optical element is configured to convert a Gaussian input beam introduced to the first surface into an output beam from the second surface with a substantially flat irradiance profile along at least one axis.

2. The optical element of claim 1, wherein both the first surface and the second surface are substantially planar.

3. The optical element of claim 1, wherein a profile of the refractive index of the optical element is concave up at the center of the optical element.

4. The optical element of claim 3, wherein the profile of the refractive index of the optical element is symmetric about a mid-plane of the optical element.

5. The optical element of claim 1, wherein a gradient of the refractive index of the optical element from the center of the optical element to the perimeter of the optical element is defined by the equation:
Δn≈(A·0.0312)/t
wherein Δn is the gradient of the refractive index, t is a thickness of the optical element, and A is a fan angle of the output beam.

6. The optical element of claim 1, wherein a profile of the refractive index of the optical element is configured such that the optical element converts the Gaussian input beam introduced to the first surface such that the output beam from the second surface has a substantially flat irradiance profile along two axes.

7. The optical element of claim 1, wherein the second surface is concave.

8. The optical element of claim 7, wherein a profile of the refractive index of the optical element is concave up at the center of the optical element.

9. The optical element of claim 8, wherein the profile of the refractive index of the optical element is concave down near the perimeter of the optical element.

10. An optical system, comprising:
an optical element, comprising:
a first surface; and
an opposed second surface;
wherein a refractive index of the optical element varies from a center of the optical element to a perimeter of the optical element such that the optical element is configured to convert a Gaussian input beam introduced to the first surface into an output beam from the second surface with a substantially flat irradiance profile along at least one axis.

11. The optical system of claim 10, wherein both the first surface and the second surface of the optical element are substantially planar.

12. The optical system of claim 10, wherein a profile of the refractive index of the optical element is concave up at the center of the optical element.

13. The optical system of claim 12, wherein the profile of the refractive index of the optical element is symmetric about a mid-plane of the optical element.

14. The optical system of claim 10, wherein a gradient of the refractive index of the optical element from the center of the optical element to the perimeter of the optical element is defined by the equation:
Δn≈(A·0.0312)/t
wherein Δn is the gradient of the refractive index, t is a thickness of the optical element, and A is a fan angle of the output beam.

15. The optical system of claim 10, wherein a profile of the refractive index of the optical element is configured such that the optical element converts the Gaussian input beam introduced to the first surface such that the output beam from the second surface has a substantially flat irradiance profile along two axes.

16. The optical system of claim 10, wherein the second surface is concave.

17. The optical system of claim 16, wherein a profile of the refractive index of the optical element is concave up at the center of the optical element.

18. The optical system of claim 17, wherein the profile of the refractive index of the optical element is concave down near the perimeter of the optical element.

19. An optical element, comprising:
a first surface, wherein an optical axis of the optical element is orthogonal to the first surface; and
an opposed second surface;
wherein the optical element has a refractive index that varies along an axis perpendicular to the optical axis, and wherein a profile of the refractive index of the optical element is concave up at a center of the optical element.

20. The optical element of claim 19, wherein both the first surface and the second surface are substantially planar.

21. The optical element of claim 19, wherein a gradient of the refractive index of the optical element from the center of the optical element to a perimeter of the optical element is defined by the equation:
Δn≈(A·0.0312)/t
wherein Δn is the gradient of the refractive index, t is a thickness of the optical element, and A is a fan angle of an output beam from the second surface.

22. The optical element of claim 19, wherein the profile of the refractive index of the optical element is configured such that the optical element converts a Gaussian input beam introduced to the first surface to an output beam from the second surface that has a substantially flat irradiance profile along two axes that are each perpendicular to the optical axis.

23. The optical element of claim 19, wherein the second surface is concave.

24. The optical element of claim 23, wherein the profile of the refractive index of the optical element is concave down near a perimeter of the optical element.

25. The optical element of claim 19, wherein the profile of the refractive index is configured such that the optical element converts a Gaussian input beam introduced to the first surface to an output beam from the second surface, and wherein an irradiance of the output beam is higher at edges of the output beam than in a center of the output beam.

26. The optical element of claim 19, wherein the profile of the refractive index of the optical element is symmetric about a mid-plane of the optical element.

27. An optical system, comprising:
an optical element, comprising:
a first surface, wherein an optical axis of the optical element is orthogonal to the first surface; and
an opposed second surface;
wherein the optical element has a refractive index that varies along an axis perpendicular to the optical axis, and wherein a profile of the refractive index of the optical element is concave up at a center of the optical element.

28. The optical system of claim 27, further comprising a laser source.

29. The optical system of claim 27, wherein a gradient of the refractive index of the optical element from the center of the optical element to a perimeter of the optical element is defined by the equation:
Δn≈(A·0.0312)/t
wherein Δn is the gradient of the refractive index, t is a thickness of the optical element, and A is a fan angle of an output beam from the second surface.

30. The optical system of claim 27, wherein the profile of the refractive index of the optical element is configured such that the optical element converts a Gaussian input beam introduced to the first surface to an output beam from the second surface that has a substantially flat irradiance profile along two axes that are each perpendicular to the optical axis.

31. The optical system of claim 27, wherein the profile of the refractive index of the optical element is symmetric about a mid-plane of the optical element.
